(19) United States
(12) Patent Application Publication
(10) Pub. No.: US 2026/0084437 A1
(43) Pub. Date: Mar. 26, 2026

(54) IMAGE FORMING APPARATUS CAPABLE OF IMPROVING IMAGE QUALITY OF IMAGE FORMED ON SHEET, AND DETERMINATION METHOD

(71) Applicant: KYOCERA Document Solutions Inc., Osaka (JP)

(72) Inventors: Masaru Masuko, Osaka (JP); Hiroki Tanaka, Osaka (JP)

(21) Appl. No.: 19/335,885

(22) Filed: Sep. 22, 2025

(30) Foreign Application Priority Data
Sep. 26, 2024 (JP) 2024-167326

(51) Int. Cl. B41J 2/21; G06K 15/10

(52) U.S. Cl. CPC B41J 2/2135; B41J 2/2121; B41J 2/2146; G06K 15/102

(57) ABSTRACT

An image forming apparatus includes a first ejection portion, a second ejection portion, a detection processing portion, and a determination processing portion. The first ejection portion includes a plurality of first nozzles. The second ejection portion includes a plurality of second nozzles. The detection processing portion detects, for each line data included in image data, edges included in a correspondence area corresponding to an overlapping portion between the plurality of first nozzles and the plurality of second nozzles in the line data. The determination processing portion determines, when the edges are detected, a division position for dividing the line data based on a position of any of the edges, and randomly determines, when the edges are not detected, the division position in the correspondence area.

### INCORPORATION BY REFERENCE

This application is based upon and claims the benefit of priority from the corresponding Japanese Patent Application No. 2024-167326 filed on September 26, 2024, the entire contents of which are incorporated herein by reference.

### BACKGROUND

The present disclosure relates to an image forming apparatus and a determination method.

There is known an inkjet image forming apparatus including a first ejection portion and a second ejection portion. The first ejection portion includes a plurality of first nozzles arranged along a width direction orthogonal to a conveying direction of a sheet, and causes ink to be ejected from each of the first nozzles. The second ejection portion includes a plurality of second nozzles arranged along the width direction, some of the plurality of second nozzles being arranged so as to overlap with some of the plurality of first nozzles in the width direction, and causes the ink to be ejected from each of the second nozzles.

In the image forming apparatus, image data used for driving the first ejection portion and the second ejection portion is sometimes divided into first image data used for driving the first ejection portion and second image data used for driving the second ejection portion. For example, there is known an image forming apparatus in which any position along a main scanning direction in a correspondence area that is included in the image data and corresponds to an overlapping portion between the plurality of first nozzles and the plurality of second nozzles is determined as a division position for dividing the image data into the first image data and the second image data.

### SUMMARY

An image forming apparatus according to an aspect of the present disclosure includes a first ejection portion, a second ejection portion, a detection processing portion, and a determination processing portion. The first ejection portion includes a plurality of first nozzles arranged along a width direction orthogonal to a conveying direction of a sheet, and causes ink to be ejected from each of the first nozzles. The second ejection portion includes a plurality of second nozzles arranged along the width direction, some of the plurality of second nozzles being arranged so as to overlap with some of the plurality of first nozzles in the width direction, and causes the ink to be ejected from each of the second nozzles. The detection processing portion detects, for each line data for one line along a main scanning direction corresponding to the width direction, that is included in image data used for driving the first ejection portion and the second ejection portion, edges included in a correspondence area corresponding to an overlapping portion between the plurality of first nozzles and the plurality of second nozzles in the line data. The determination processing portion determines, when the edges are detected by the detection processing portion, a division position for dividing the line data into first line data used for driving the first ejection portion and second line data used for driving the second ejection portion based on a position of the edge on an upstream side or a downstream side of a specific direction along the main scanning direction out of the edges included in the correspondence area, and randomly determines, when the edges are not detected by the detection processing portion, the division position in the correspondence area.

A determination method according to another aspect of the present disclosure is executed in an image forming apparatus including a first ejection portion which includes a plurality of first nozzles arranged along a width direction orthogonal to a conveying direction of a sheet, and causes ink to be ejected from each of the first nozzles, and a second ejection portion which includes a plurality of second nozzles arranged along the width direction, some of the plurality of second nozzles being arranged so as to overlap with some of the plurality of first nozzles in the width direction, and causes the ink to be ejected from each of the second nozzles, and includes a detection step and a determination step. The detection step includes detecting, for each line data for one line along a main scanning direction corresponding to the width direction, that is included in image data used for driving the first ejection portion and the second ejection portion, edges included in a correspondence area corresponding to an overlapping portion between the plurality of first nozzles and the plurality of second nozzles in the line data. The determination step includes determining, when the edges are detected in the detection step, a division position for dividing the line data into first line data used for driving the first ejection portion and second line data used for driving the second ejection portion based on a position of the edge on an upstream side or a downstream side of a specific direction along the main scanning direction out of the edges included in the correspondence area, and randomly determining, when the edges are not detected in the detection step, the division position in the correspondence area.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to a first embodiment of the present disclosure;

FIG. 2 is a diagram showing configurations of an image forming portion and a conveying unit in the image forming apparatus according to the first embodiment of the present disclosure;

FIG. 3 is a diagram showing a configuration in a periphery of a nozzle in the image forming apparatus according to the first embodiment of the present disclosure;

FIG. 4 is a block diagram showing a system configuration of the image forming apparatus according to the first embodiment of the present disclosure;

FIG. 5 is a flowchart showing an example of first data division processing executed in the image forming apparatus according to the first embodiment of the present disclosure;

FIG. 6 is a diagram showing an example of determining a division position in each line data;

FIG. 7 is a diagram showing a print image that is based on each line data divided at the division position shown in FIG. 6;

FIG. 8 is a diagram showing an example of the division position determined for each line data by the image forming apparatus according to the first embodiment of the present disclosure;

FIG. 9 is a diagram showing a print image that is based on each line data divided at the division position shown in FIG. 8;

FIG. 10 is a diagram showing an example of the division position determined for each line data by the image forming apparatus according to the first embodiment of the present disclosure;

FIG. 11 is a diagram showing a print image that is based on each line data divided at the division position shown in FIG. 10;

FIG. 12 is a block diagram showing a system configuration of an image forming apparatus according to a second embodiment of the present disclosure;

FIG. 13 is a flowchart showing an example of second data division processing executed in the image forming apparatus according to the second embodiment of the present disclosure;

FIG. 14 is a diagram showing an example of the division position determined for each line data by the image forming apparatus according to the second embodiment of the present disclosure; and

FIG. 15 is a diagram showing a print image that is based on each line data divided at the division position shown in FIG. 14.

### DETAILED DESCRIPTION

Hereinafter, embodiments of the present disclosure will be described with reference to the attached drawings. It is noted that the following embodiments are each an example of embodying the present disclosure and do not limit the technical scope of the present disclosure.

### First embodiment

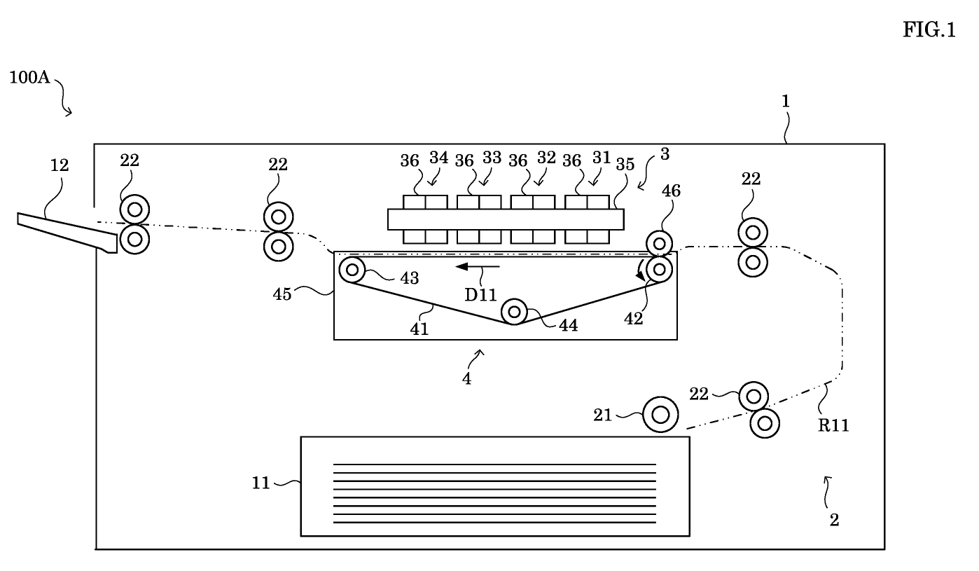

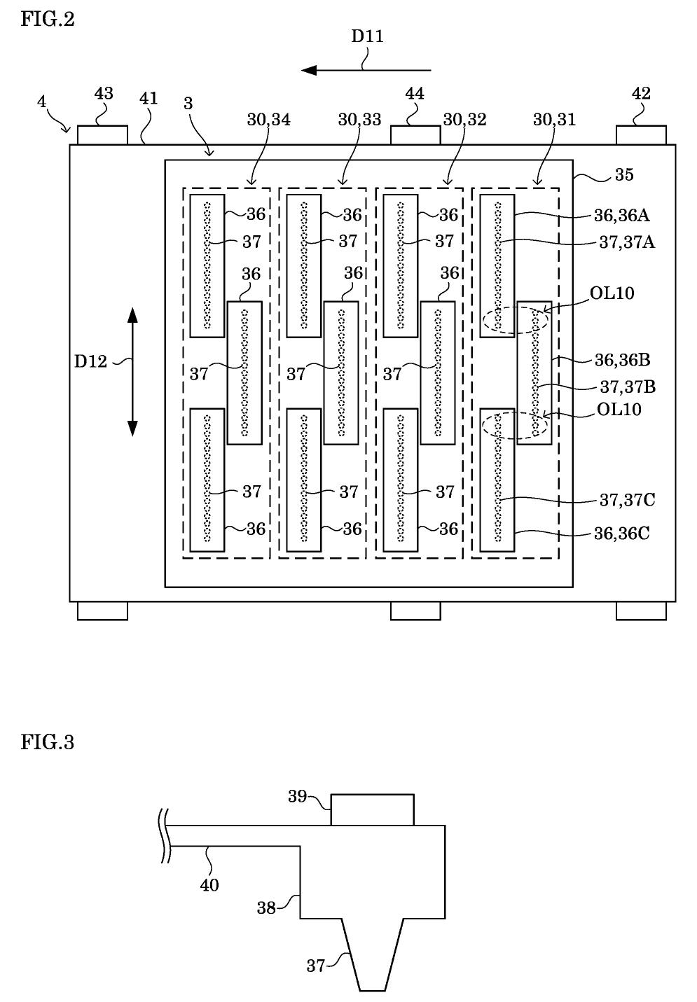

First, a configuration of an image forming apparatus 100A according to a first embodiment of the present disclosure will be described with reference to FIGS. 1 to 4. Herein, FIG. 1 is a cross-sectional view showing the configuration of the image forming apparatus 100A. Further, FIG. 2 is a plan view showing configurations of an image forming portion 3 and a conveying unit 4. Furthermore, FIG. 3 is a cross-sectional view showing configurations of a nozzle 37, a pressure chamber 38, a piezoelectric element 39, and an individual flow path 40. It is noted that in FIG. 1, a sheet conveying path R11 is indicated by a dash-dot-dot line. Moreover, in FIG. 2, overlapping areas OL10 are indicated by broken lines.

The image forming apparatus 100A is a printer capable of forming an image on a sheet by an inkjet method. It is noted that the present disclosure may also be applied to a facsimile apparatus, a copying machine, a multifunction peripheral, and the like that are capable of forming an image on a sheet by the inkjet method.

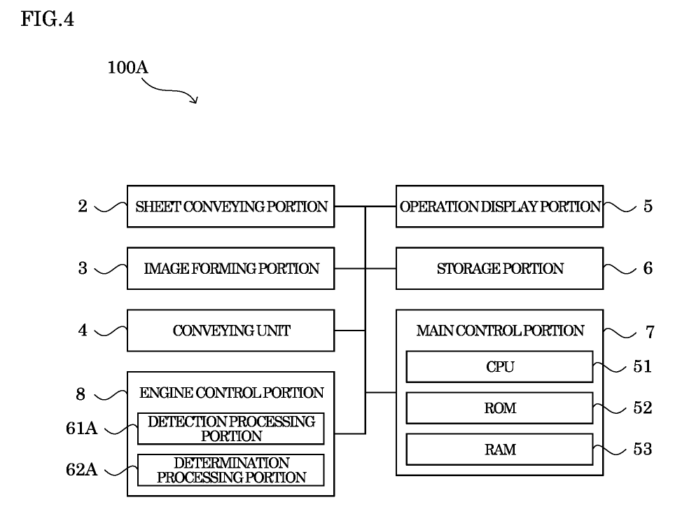

As shown in FIGS. 1 and 4, the image forming apparatus 100A includes a housing 1, a sheet conveying portion 2, the image forming portion 3, the conveying unit 4, an operation display portion 5, a storage portion 6, a main control portion 7, and an engine control portion 8.

The housing 1 houses respective constituent elements of the image forming apparatus 100A. A sheet feed cassette 11 (see FIG. 1) is detachably provided in the housing 1. The sheet feed cassette 11 stores sheets on which images are to be formed. A sheet discharge tray 12 (see FIG. 1) is provided on an outer side surface of the housing 1. Sheets on which images have been formed by the image forming portion 3 are discharged onto the sheet discharge tray 12. Inside the housing 1, the sheets stored in the sheet feed cassette 11 are conveyed along the sheet conveying path R11 (see FIG. 1) that passes through an image forming position by the image forming portion 3 and reaches the sheet discharge tray 12.

The sheet conveying portion 2 conveys the sheets stored in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 picks up an uppermost sheet in a stack of sheets stored in the sheet feed cassette 11 and feeds the sheet to the sheet conveying path R11. The plurality of conveying rollers 22 are provided while being aligned along the sheet conveying path R11. Each of the conveying rollers 22 conveys the sheet along the sheet conveying path R11. Each of the conveying rollers 22 conveys the sheet in a conveying direction D11 (see FIG. 1) directed from the sheet feed cassette 11 to the sheet discharge tray 12.

The image forming portion 3 forms an image on the sheet conveyed by the sheet conveying portion 2. As shown in FIGS. 1 and 2, the image forming portion 3 includes four line heads 30 (31 to 34) and a head frame 35.

As shown in FIG. 2, each of the line heads 30 is elongated in a width direction D12 orthogonal to the conveying direction D11. Specifically, each of the line heads 30 has, in the width direction D12, a length corresponding to a width of a sheet of a largest size out of the sheets that can be stored in the sheet feed cassette 11. The four line heads 30 are provided while being aligned at regular intervals along the conveying direction D11.

As shown in FIG. 2, each of the line heads 30 includes a plurality of recording heads 36. Each of the recording heads 36 ejects ink droplets toward a sheet conveyed by the conveying unit 4. Each of the recording heads 36 provided in the line head 31 ejects black ink droplets. Each of the recording heads 36 provided in the line head 32 ejects cyan ink droplets. Each of the recording heads 36 provided in the line head 33 ejects magenta ink droplets. Each of the recording heads 36 provided in the line head 34 ejects yellow ink droplets.

Each of the recording heads 36 includes a plurality of nozzles 37 (see FIGS. 2 and 3) that eject ink droplets onto a sheet. Each of the nozzles 37 is provided on a surface of the recording head 36 that opposes a sheet conveyed by the conveying unit 4. For example, in the image forming apparatus 100A, small-size, medium-size, or large-size ink droplets are ejected from the nozzles 37.

Each of the recording heads 36 also includes pressure chambers 38 (see FIG. 3), piezoelectric elements 39 (see FIG. 3), and individual flow paths 40 (see FIG. 3) that respectively correspond to the nozzles 37. The pressure chamber 38 communicates with the nozzle 37 and stores ink therein. The piezoelectric element 39 varies a pressure in the pressure chamber 38 according to an input of a drive signal, to thus cause the ink droplets to be ejected from the nozzle 37. The individual flow path 40 is an ink flow path provided between the pressure chamber 38 and a common flow path (not shown) common to the plurality of nozzles 37. Connected to the common flow path are the plurality of individual flow paths 40 respectively corresponding to the plurality of nozzles 37. The common flow path is connected to an ink supply portion (not shown) that supplies ink to each of the pressure chambers 38.

As shown in FIG. 2, the line head 31 includes three recording heads 36 (36A, 36B, and 36C).

The recording head 36A includes a plurality of nozzles 37A (see FIG. 2) arranged along the width direction D12 orthogonal to the conveying direction D11, and causes ink to be ejected from each of the nozzles 37A. The recording head 36B includes a plurality of nozzles 37B (see FIG. 2) arranged along the width direction D12, and causes ink to be ejected from each of the nozzles 37B. The recording head 36C includes a plurality of nozzles 37C (see FIG. 2) arranged along the width direction D12, and causes ink to be ejected from each of the nozzles 37C.

The three recording heads 36 included in the line head 31 are arranged in a staggered pattern along the width direction D12.

Specifically, as shown in FIG. 2, the recording head 36B is arranged such that some of the plurality of nozzles 37B overlap with some of the plurality of nozzles 37A in the width direction D12. Also, the recording head 36C is arranged such that some of the plurality of nozzles 37C overlap with some of the plurality of nozzles 37B in the width direction D12. In the present specification, overlapping areas between the plurality of nozzles 37 included in any one of the three recording heads 36 and the plurality of nozzles 37 included in the other recording heads 36 in the width direction D12 will each be referred to as an "overlapping area OL10" (see FIG. 2). The recording head 36A is an example of a first ejection portion according to the present disclosure. Further, the nozzles 37A are an example of first nozzles according to the present disclosure. Furthermore, the recording head 36B is an example of a second ejection portion according to the present disclosure. Moreover, the nozzles 37B are an example of second nozzles according to the present disclosure.

The line heads 32 to 34 each include three recording heads 36 arranged in a manner similar to that of the line head 31.

It is noted that the number of recording heads 36 to be provided in each of the line head 30 does not need to be limited to three.

The head frame 35 supports the four line heads 30. The head frame 35 is supported by the housing 1. It is noted that the number of line heads 30 to be provided in the image forming portion 3 does not need to be limited to four.

As shown in FIG. 1, the conveying unit 4 is arranged below the four line heads 30. The conveying unit 4 conveys a sheet while causing the sheet to oppose the recording heads 36. As shown in FIG. 1, the conveying unit 4 includes a conveying belt 41 on which a sheet is placed, a first tension roller 42, a second tension roller 43, and a third tension roller 44 across which the conveying belt 41 is stretched, and a conveying frame 45 that supports them. It is noted that a gap between the conveying belt 41 and the recording heads 36 is adjusted so that a gap between a surface of the sheet and the recording heads 36 during image formation becomes a predetermined distance (for example, 1 mm).

The first tension roller 42 is rotationally driven by a rotational driving force supplied from a motor (not shown). Thus, the conveying belt 41 rotates in a direction in which the sheet can be conveyed in the conveying direction D11 (see FIG. 1). It is noted that the conveying unit 4 is also provided with a suction unit (not shown) or the like that sucks air from a large number of through-holes formed in the conveying belt 41 in order to cause the sheet to stick to the conveying belt 41. Further, a pressure roller 46 for conveying the sheet while pressing the sheet against the conveying belt 41is provided above the first tension roller 42.

The operation display portion 5 includes a display portion such as a liquid crystal display that displays various types of information in response to control instructions from the main control portion 7 and an operation portion such as an operation key or a touch panel that is used to input various types of information to the main control portion 7 according to user operations.

The storage portion 6 is a non-volatile storage device. For example, the storage portion 6 is a non-volatile memory such as a flash memory.

The main control portion 7 collectively controls the image forming apparatus 100A. As shown in FIG. 4, the main control portion 7 includes a CPU 51, a ROM 52, and a RAM 53. The CPU 51 is a processor that executes various types of arithmetic processing. The ROM 52 is a non-volatile storage device in which information such as control programs for causing the CPU 51 to execute various types of processing is stored in advance. The RAM 53 is a volatile or non-volatile storage device that is used as a temporary storage memory (working area) for the various types of processing to be executed by the CPU 51. The CPU 51 executes the various control programs stored in advance in the ROM 52 to collectively control the image forming apparatus 100A.

The engine control portion 8 controls the sheet conveying portion 2, the image forming portion 3, and the conveying unit 4. For example, the engine control portion 8 is constituted of an electronic circuit such as an integrated circuit (ASIC, DSP).

Further, the engine control portion 8 executes image processing on image data for one page of a document sheet to be printed. For example, the image processing includes decomposition processing for decomposing the image data into monochrome image data corresponding to each of the colors black, cyan, magenta, and yellow.

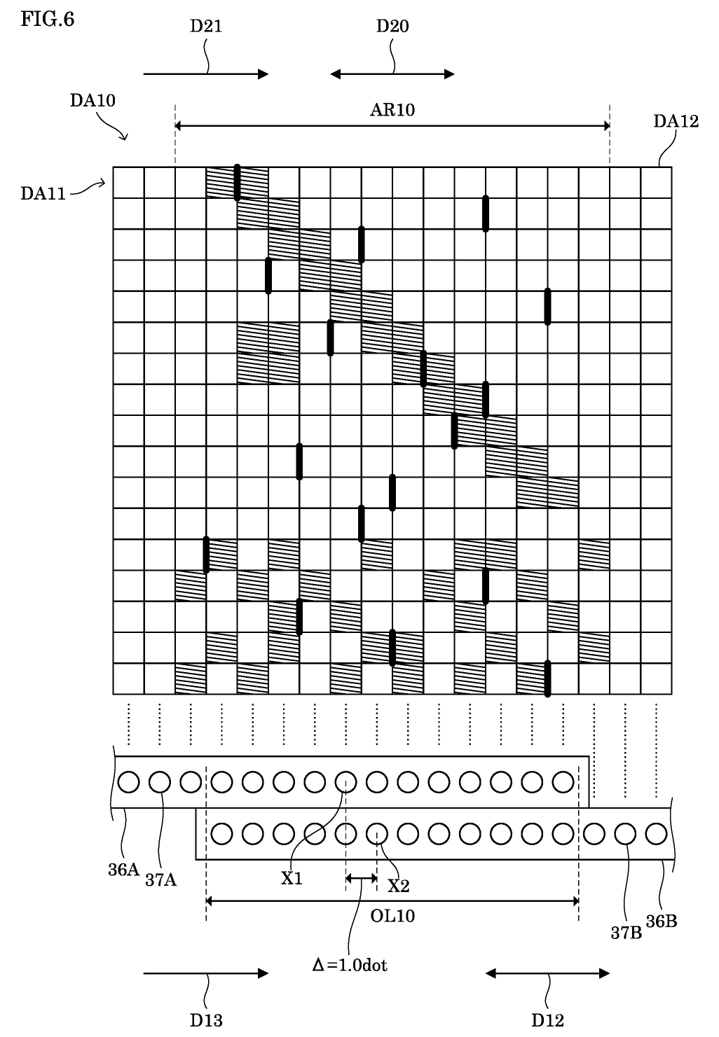

The image processing also includes conversion processing for converting the monochrome image data into print data DA10 (see FIG. 6) that is used for driving the three recording heads 36 included in the line head 30. The print data DA10 includes ejection amount data DA12 (see FIG. 6) that corresponds to each of the nozzles 37 and indicates an ejection amount of the ink from the nozzle 37. The print data DA10 is an example of image data according to the present disclosure.

For example, the ejection amount data DA12 is data indicating any one of values of "0", "1", "2", and "3". In response to an input of the ejection amount data DA12 indicating the value of "3", the recording head 36 causes large-size ink droplets to be ejected from the nozzle 37 corresponding to the ejection amount data DA12. In response to an input of the ejection amount data DA12 indicating the value of "2", the recording head 36 causes medium-size ink droplets to be ejected from the nozzle 37 corresponding to the ejection amount data DA12. In response to an input of the ejection amount data DA12 indicating the value of "1", the recording head 36 causes small-size ink droplets to be ejected from the nozzle 37 corresponding to the ejection amount data DA12. When the ejection amount data DA12 indicating the value of "0" is input, the recording head 36 does not cause ink droplets to be ejected from the nozzle 37 corresponding to the ejection amount data DA12. It is noted that in FIG. 6, the ejection amount data DA12 indicating the value of "1", "2", or "3" is hatched.

Incidentally, there is known a configuration in which any position along a main scanning direction D20 (see FIG. 6) in a correspondence area AR10 (see FIG. 6) that is included in the print data DA10 (see FIG. 6) and corresponds to the overlapping area OL10 (see FIG. 6) that is an overlapping portion between the plurality of nozzles 37A (see FIG. 6) and the plurality of nozzles 37B (see FIG. 6) is determined as a division position for dividing the print data DA10 into data used for driving the recording head 36A and data used for driving the recording head 36B. The main scanning direction D20 is a direction corresponding to the width direction D12.

Herein, a configuration in which, for each line data DA11 (see FIG. 6) for one line along the main scanning direction D20 that is included in the print data DA10, the division position is randomly determined in the correspondence area AR10 (see FIG. 6) in the line data DA11 is conceivable. Thus, it is possible to suppress generation of a streak image along the conveying direction D11 in the image formed on the sheet as compared to a configuration in which the division position is fixed.

However, in the configuration in which the division position is randomly determined in the correspondence area AR10 for each line data DA11, when the print data DA10 includes an edge that extends in a direction intersecting with the main scanning direction D20, jitter may occur in the edge included in the image formed on the sheet.

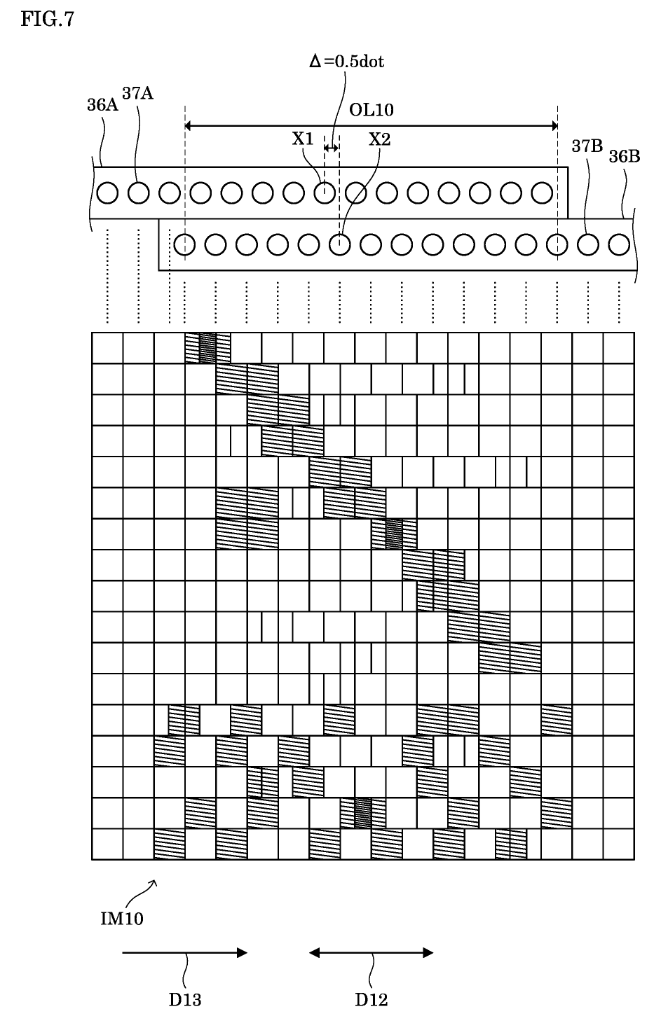

Specifically, in the image forming apparatus 100A, a positional relationship between the recording head 36A and the recording head 36B in the width direction D12 may be deviated from an ideal state. FIG. 6 shows the nozzles 37A and the nozzles 37B in a case where the positional relationship between the recording head 36A and the recording head 36B in the width direction D12 is ideal. FIG. 7 shows the nozzles 37A and the nozzles 37B in a case where the positional relationship between the recording head 36A and the recording head 36B in the width direction D12 is deviated from the ideal state.

When the positional relationship between the recording head 36A and the recording head 36B in the width direction D12 is ideal, a separation distance Δ between a specific nozzle X1 (see FIG. 6) included in the recording head 36A and a specific nozzle X2 (see FIG. 6) included in the recording head 36B in the width direction D12 becomes a distance corresponding to one dot (a nozzle interval in the recording head 36) as shown in FIG. 6. Herein, the specific nozzle X1 is any nozzle included in the overlapping area OL10 out of the plurality of nozzles 37A included in the recording head 36A. In addition, the specific nozzle X2 is a nozzle closest to the specific nozzle X1 out of the nozzles 37B positioned more on a downstream side of a first direction D13 (see FIG. 6) than the specific nozzle X1. The first direction D13 is a direction that is directed from the recording head 36A to the recording head 36B along the width direction D12.

When the positional relationship between the recording head 36A and the recording head 36B in the width direction D12 is deviated from the ideal state, the separation distance Δ between the specific nozzle X1 (see FIG. 7) and the specific nozzle X2 (see FIG. 7) becomes smaller than the distance corresponding to one dot as shown in FIG. 7.

When the division position is randomly determined in the correspondence area AR10 for each line data DA11 as shown in FIG. 6 in the case where the positional relationship between the recording head 36A and the recording head 36B in the width direction D12 is deviated from the ideal state, jitter occurs at an edge of a line image that is included in an image IM10 (see FIG. 7) formed on the sheet and extends in a direction intersecting with the width direction D12 as shown in FIG. 7. It is noted that in FIG. 6, the division position randomly determined for each line data DA11 is indicated by a thick black line.

In contrast, in the image forming apparatus 100A according to the first embodiment of the present disclosure, image quality of an image formed on a sheet can be improved as will be described below.

Specifically, the engine control portion 8 includes a detection processing portion 61A and a determination processing portion 62A shown in FIG. 4.

It is noted that the main control portion 7 may include the detection processing portion 61A and the determination processing portion 62A instead of the engine control portion 8. Specifically, the CPU 51 of the main control portion 7 may execute the control programs stored in advance in the ROM 52 to function as the respective processing portions described above.

The detection processing portion 61A detects, for each line data DA11 included in the print data DA10, an edge included in the correspondence area AR10 in the line data DA11.

For example, the detection processing portion 61A detects, as the edge, a portion of the correspondence area AR10 where a row of the ejection amount data DA12 indicating that the ejection amount of the ink is zero and a row of the ejection amount data DA12 indicating that the ejection amount of the ink is not zero are adjacent to each other. For example, the detection processing portion 61A detects, as the edge, a portion of the correspondence area AR10 where a row including three or more consecutive pieces of ejection amount data DA12 indicating that the ejection amount of the ink is zero and a row including two or more consecutive pieces of ejection amount data DA12 indicating that the ejection amount of the ink is not zero are adjacent to each other.

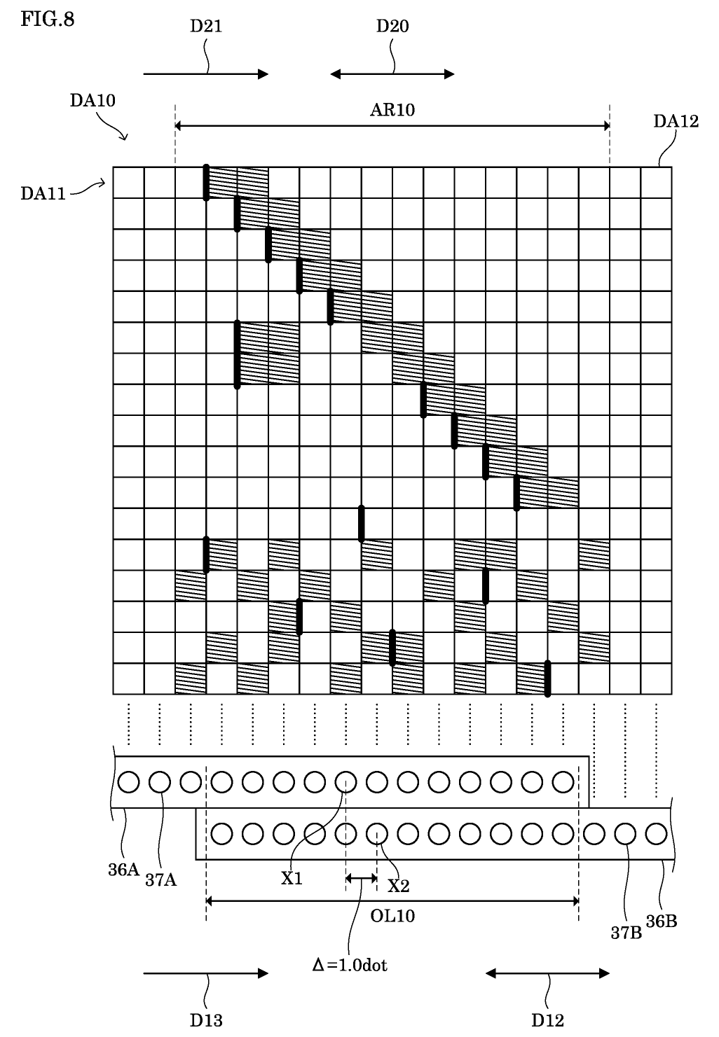

For example, the detection processing portion 61A executes first detection processing for detecting a first edge where the ejection amount of the ink increases along a second direction D21 (see FIG. 8) along the main scanning direction D20 and second detection processing for detecting a second edge where the ejection amount of the ink increases along a direction opposite to the second direction D21, in the stated order of the first detection processing and the second detection processing. It is noted that the detection processing portion 61A may execute the first detection processing and the second detection processing in the stated order of the second detection processing and the first detection processing.

For example, the detection processing portion 61A detects the edges included in the correspondence area AR10 by a pattern matching method that uses a pattern for detecting an edge.

It is noted that the detection processing portion 61A may alternatively detect the edges included in the correspondence area AR10 using a conventional well-known method.

When the edges are detected by the detection processing portion 61A, the determination processing portion 62A determines, based on a position of an edge on an upstream side or a downstream side of the second direction D21 (see FIG. 8) (an example of a specific direction according to the present disclosure) along the main scanning direction D20 out of the edges included in the correspondence area AR10, a division position for dividing the line data DA11 into first line data used for driving the recording head 36A and second line data used for driving the recording head 36B.

For example, when the edges are detected by the detection processing portion 61A, the determination processing portion 62A determines the position of the edge on the upstream side or the downstream side of the second direction D21 out of the edges included in the correspondence area AR10 as the division position (see FIG. 8).

For example, the determination processing portion 62A determines, when the first edge is detected by the first detection processing, a position of the first edge that is most upstream in the second direction D21 as the division position, and determines, when the first edge is not detected by the first detection processing and the second edge is detected by the second detection processing, a position of the second edge that is most downstream in the second direction D21 as the division position.

Furthermore, when no edge is detected by the detection processing portion 61A, the determination processing portion 62A randomly determines the division positions in the correspondence area AR10 (see FIG. 8).

For example, the determination processing portion 62A determines the division positions in the correspondence area AR10 using a random number table.

The second direction D21 may be any direction along the main scanning direction D20.

### First data division processing

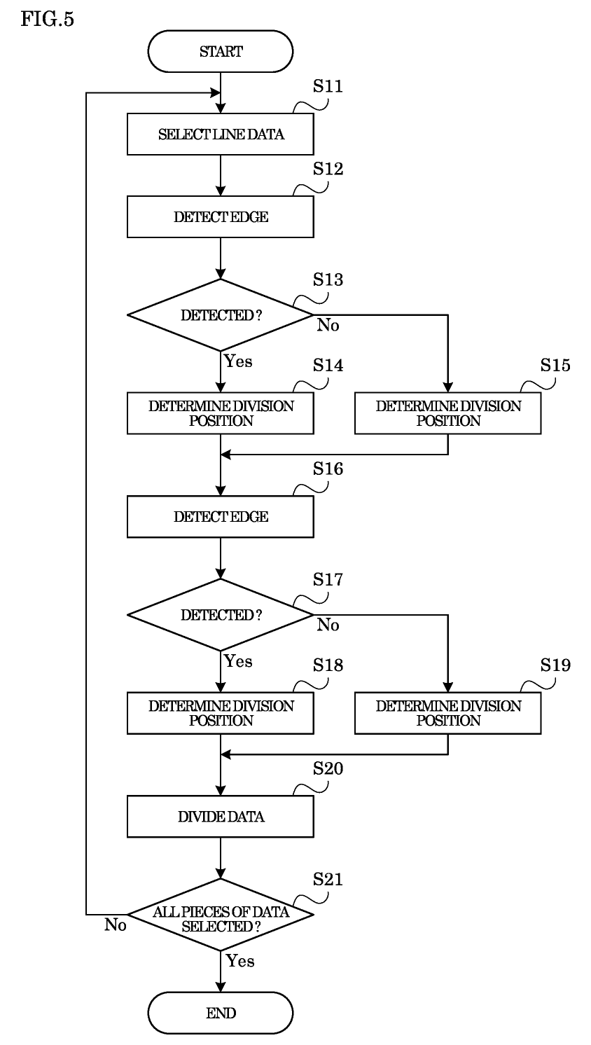

Next, with reference to FIG. 5, a determination method according to the present disclosure will be described along with exemplary procedures of first data division processing executed by the engine control portion 8. Herein, Step S11, Step S12, ... represent numbers of processing procedures (steps) executed by the engine control portion 8. It is noted that the engine control portion 8 executes the first data division processing when executing print processing for printing a document sheet. In addition, the engine control portion 8 executes the first data division processing for each of the colors of black, cyan, magenta, and yellow.

### Step S11

First, in Step S11, the engine control portion 8 selects one piece of line data DA11 to be divided out of a plurality of pieces of line data DA11 included in the print data DA10 to be printed.

### Step S12

In Step S12, the engine control portion 8 detects edges included in the correspondence area AR10 corresponding to the overlapping area OL10 where the recording head 36A and the recording head 36B overlap in the line data DA11 to be divided. The processing of Step S12 is an example of a detection step according to the present disclosure and is executed by the detection processing portion 61A of the engine control portion 8.

Specifically, the engine control portion 8 detects, as the edge, a portion of the correspondence area AR10 where a row including three or more consecutive pieces of the ejection amount data DA12 indicating that the ejection amount of the ink is zero and a row including two or more consecutive pieces of the ejection amount data DA12 indicating that the ejection amount of the ink is not zero are adjacent to each other. Further, the engine control portion 8 executes the first detection processing and the second detection processing in the stated order of the first detection processing and the second detection processing.

### Step S13

In Step S13, the engine control portion 8 determines whether or not an edge has been detected by the processing of Step S12.

Herein, when determining that an edge has been detected (Yes in S13), the engine control portion 8 shifts the processing to Step S14. On the other hand, when determining that an edge has not been detected (No in S13), the engine control portion 8 shifts the processing to Step S15.

<Step S14>

In Step S14, the engine control portion 8 determines the division position based on the position of the edge on the upstream side or the downstream side of the second direction D21 out of the edges included in the correspondence area AR10 corresponding to the overlapping area OL10 where the recording head 36A and the recording head 36B overlap. The processing of Step S14 is an example of a determination step according to the present disclosure and is executed by the determination processing portion 62A of the engine control portion 8.

Specifically, the engine control portion 8 determines, when the first edge is detected by the first detection processing, the position of the first edge that is most upstream in the second direction D21 as the division position, and determines, when the first edge is not detected by the first detection processing and the second edge is detected by the second detection processing, the position of the second edge that is most downstream in the second direction D21 as the division position.

### Step S15

In Step S15, the engine control portion 8 randomly determines the division position in the correspondence area AR10 corresponding to the overlapping area OL10 where the recording head 36A and the recording head 36B overlap. The processing of Step S15 is an example of the determination step according to the present disclosure and is executed by the determination processing portion 62A of the engine control portion 8.

<Step S16>

In Step S16, the engine control portion 8 detects edges included in the correspondence area AR10 corresponding to the overlapping area OL10 where the recording head 36B and the recording head 36C overlap in the line data DA11 to be divided, by the method similar to that of the processing of Step S12. The processing of Step S16 is an example of the detection step according to the present disclosure and is executed by the detection processing portion 61A of the engine control portion 8.

### Step S17

In Step S17, the engine control portion 8 determines whether or not an edge has been detected by the processing of Step S16.

Herein, when determining that an edge has been detected (Yes in S17), the engine control portion 8 shifts the processing to Step S18. On the other hand, when determining that an edge has not been detected (No in S17), the engine control portion 8 shifts the processing to Step S19.

### Step S18

In Step S18, the engine control portion 8 determines the division position based on the position of the edge on the upstream side or the downstream side of the second direction D21 out of the edges included in the correspondence area AR10 corresponding to the overlapping area OL10 where the recording head 36B and the recording head 36C overlap, by the method similar to that of the processing of Step S14. The processing of Step S18 is an example of the determination step according to the present disclosure and is executed by the determination processing portion 62A of the engine control portion 8.

### Step S19

In Step S19, the engine control portion 8 randomly determines the division position in the correspondence area AR10 corresponding to the overlapping area OL10 where the recording head 36B and the recording head 36C overlap. The processing of Step S19 is an example of the determination step according to the present disclosure and is executed by the determination processing portion 62A of the engine control portion 8.

### Step S20

In Step S20, the engine control portion 8 divides the line data DA11 to be divided into the first line data, the second line data, and third line data used for driving the recording head 36C based on the division position determined by the processing of Step S14 or Step S15 and the division position determined by the processing of Step S18 or Step S19.

The first line data, the second line data, and the third line data obtained by the division in the processing of Step S20 are used for driving the three recording heads 36 included in the line head 30. Thus, an image corresponding to the line data DA11 is formed on the sheet.

### Step S21

In Step S21, the engine control portion 8 determines whether or not all pieces of line data DA11 included in the print data DA10 to be printed have been selected by the processing of Step S11.

Herein, when determining that all pieces of line data DA11 have been selected (Yes in S21), the engine control portion 8 ends the first data division processing. On the other hand, when determining that all pieces of line data DA11 have not been selected (No in S21), the engine control portion 8 shifts the processing to Step S11.

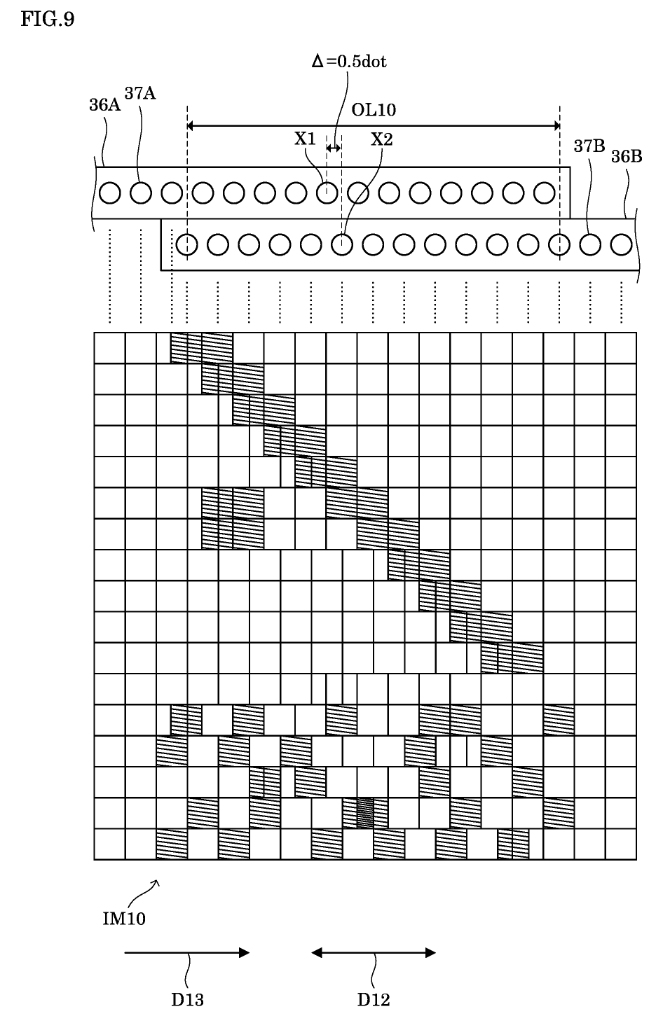

FIG. 8 shows the division positions determined by the first data division processing in a case where the print data DA10 shown in FIG. 6 is printed. Further, FIG. 9 shows the image IM10 formed on the sheet based on the first line data and the second line data obtained by the division in the first data division processing. As shown in FIG. 9, by setting the position of the edge on the upstream side or the downstream side of the second direction D21 out of the edges included in the correspondence area AR10 as the division position, jitter of the edge of the line image that is included in the image IM10 formed on the sheet and extends in the direction intersecting with the width direction D12 is suppressed.

In this manner, in the image forming apparatus 100A, for each line data DA11 included in the print data DA10, edges included in the correspondence area AR10 in the line data DA11 are detected. Then, when the edges are detected, the division position is determined based on the position of the edge on the upstream side or the downstream side of the second direction D21 out of the edges included in the correspondence area AR10. Thus, it is possible to avoid a situation where the division position is set on one side of an area sandwiching an edge in one line and the division position is set on the other side of the area sandwiching the edge in another line as shown in FIG. 6. Therefore, it is possible to suppress an occurrence of jitter at the edges included in the image formed on the sheet.

Furthermore, in the image forming apparatus 100A, when the edges are not detected, the division position is determined randomly in the correspondence area AR10. Thus, it is possible to suppress generation of a streak image along the conveying direction D11 in the image formed on the sheet.

Therefore, in the image forming apparatus 100A, it is possible to improve image quality of the image formed on the sheet.

Further, in the image forming apparatus 100A, when edges included in the correspondence area AR10 are detected, the position of the edge on the upstream side or the downstream side of the second direction D21 out of the edges included in the correspondence area AR10 is determined as the division position. Thus, it is possible to make a density change at the division position less noticeable as compared to a configuration in which the division position is set in any of density areas sectioned by the edges.

Furthermore, in the image forming apparatus 100A, a portion of the correspondence area AR10 where a row of the ejection amount data DA12 indicating that the ejection amount of the ink is zero and a row of the ejection amount data DA12 indicating that the ejection amount of the ink is not zero are adjacent to each other is detected as an edge. Thus, it is possible to suppress lowering of reproducibility of the density at the edges as compared to a configuration in which a portion of the correspondence area AR10 where a row of the ejection amount data DA12 indicating that the ejection amount of the ink is a first amount larger than zero and a row of the ejection amount data DA12 indicating that the ejection amount of the ink is a second amount larger than the first amount are adjacent to each other is also detected as an edge.

It is noted that the detection processing portion 61A may alternatively detect, as an edge, a portion of the correspondence area AR10 where a row of the ejection amount data DA12 indicating that the ejection amount of the ink is equal to or larger than a predetermined threshold value and a row of the ejection amount data DA12 indicating that the ejection amount of the ink is smaller than the threshold value are adjacent to each other.

Furthermore, when edges are detected by the detection processing portion 61A, the determination processing portion 62A may randomly determine the division position in a density area having a relatively low density out of two density areas sectioned by an edge on the upstream side or the downstream side of the second direction D21 out of the edges included in the correspondence area AR10. For example, the determination processing portion 62A only needs to randomly determine, when the first edge is detected by the first detection processing, the division position in a density area having a relatively low density out of two density areas sectioned by the first edge that is most upstream in the second direction D21, and randomly determine, when the first edge is not detected by the first detection processing and the second edge is detected by the second detection processing, the division position in a density area having a relatively low density out of two density areas sectioned by the second edge that is most downstream in the second direction D21.

Furthermore, when edges are detected by the detection processing portion 61A, the determination processing portion 62A may determine, by a predetermined determination method, the division position in a density area having a relatively low density out of two density areas sectioned by an edge on the upstream side or the downstream side of the second direction D21 out of the edges included in the correspondence area AR10. In this case, it is desirable to detect, as an edge, a portion of the correspondence area AR10 where a row of the ejection amount data DA12 indicating that the ejection amount of the ink is zero and a row of the ejection amount data DA12 indicating that the ejection amount of the ink is not zero are adjacent to each other. For example, the determination processing portion 62A only needs to determine, by the determination method, when the first edge is detected by the first detection processing, the division position in a density area having a relatively low density out of the two density areas sectioned by the first edge that is most upstream in the second direction D21, and determine, by the determination method, when the first edge is not detected by the first detection processing and the second edge is detected by the second detection processing, the division position in a density area having a relatively low density out of the two density areas sectioned by the second edge that is most downstream in the second direction D21.

Moreover, the detection processing portion 61A may detect, for each line data included in the monochrome image data (another example of the image data according to the present disclosure), an edge included in an area corresponding to the overlapping area OL10 in the line data.

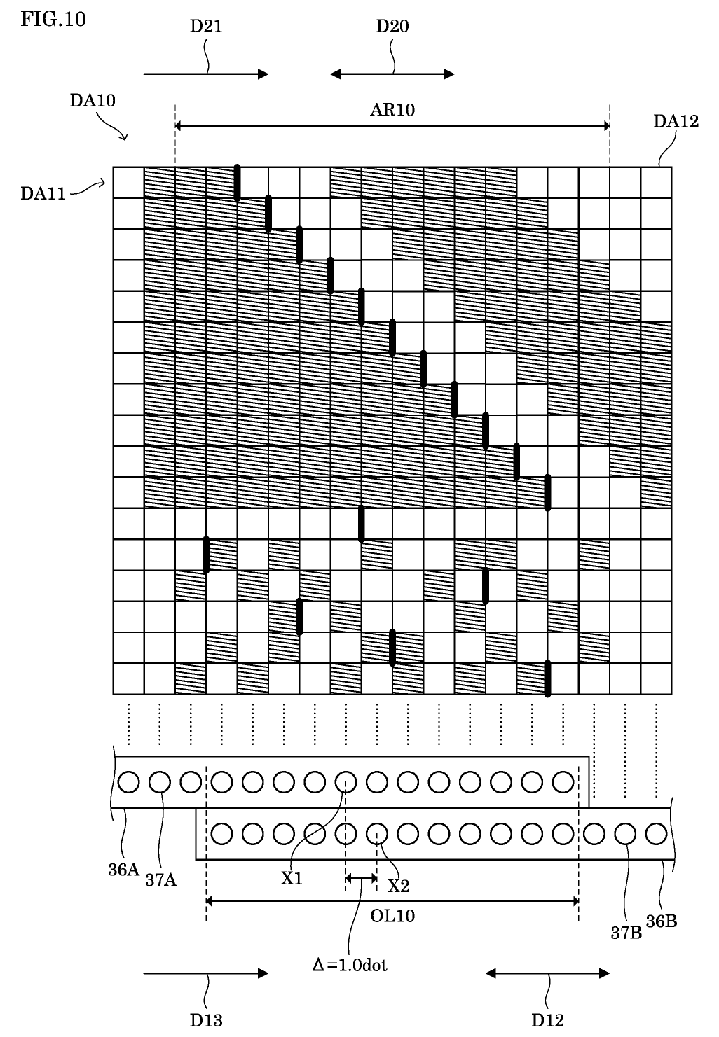

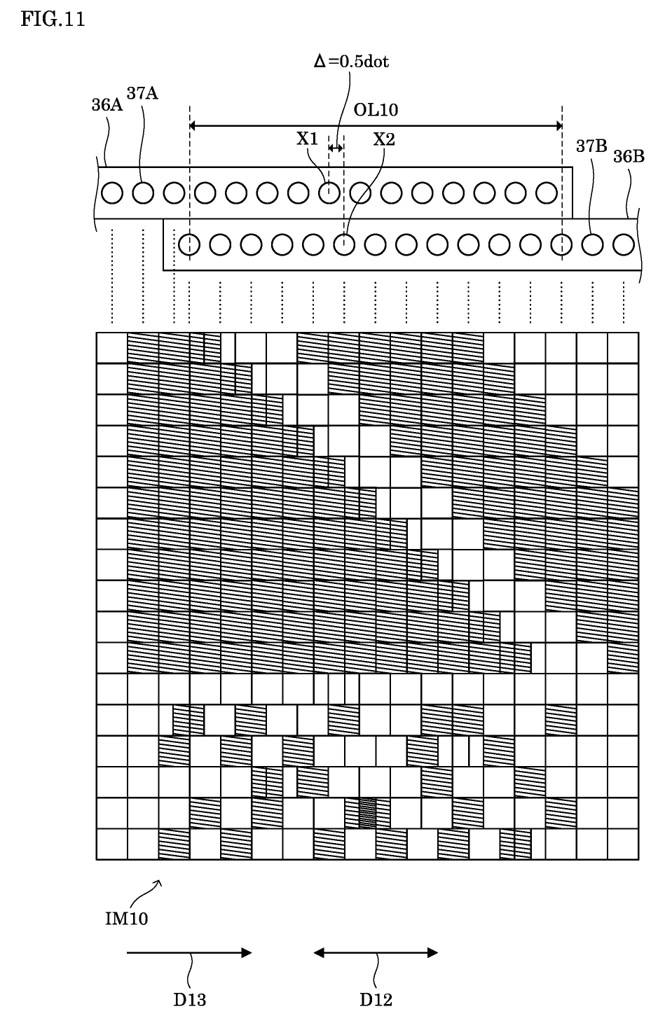

Incidentally, in the configuration in which a position of an edge on the upstream side or the downstream side of the second direction D21 out of the edges included in the correspondence area AR10 or a position in a density area having a relatively low density out of two density areas sectioned by the edge is determined as the division position, when an open line (see FIG. 10) extending in a direction intersecting with the main scanning direction D20 is present in the correspondence area AR10, a line width of the open line formed on the sheet becomes narrower than it should be, as shown in FIG. 11. In other words, in the configuration described above, reproducibility of the open line that is present in the correspondence area AR10 and extends in the direction intersecting with the main scanning direction D20 is lowered.

In contrast, in an image forming apparatus 100B according to a second embodiment of the present disclosure, it is possible to suppress lowering of reproducibility of an open line that is present in the correspondence area AR10 and extends in the direction intersecting with the main scanning direction D20 as will be described below.

### Second embodiment

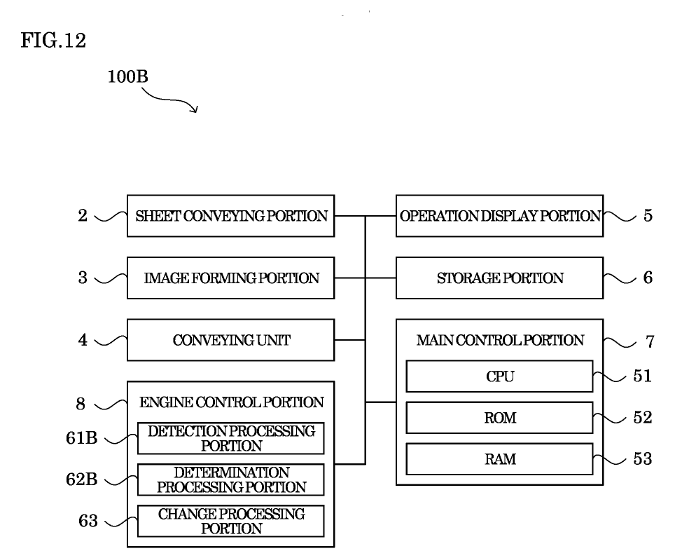

Hereinafter, a configuration of the image forming apparatus 100B according to the second embodiment of the present disclosure will be described with reference to FIG. 12.

As shown in FIGS. 4 and 12, the image forming apparatus 100B differs from the image forming apparatus 100A in the configuration of the engine control portion 8. Specifically, the engine control portion 8 of the image forming apparatus 100B includes a detection processing portion 61B, a determination processing portion 62B, and a change processing portion 63 instead of the detection processing portion 61A and the determination processing portion 62A. It is noted that other configurations are common between the image forming apparatus 100A and the image forming apparatus 100B. Hereinafter, descriptions will only be given on points of the configuration of the image forming apparatus 100B that are different from those of the image forming apparatus 100A.

The detection processing portion 61B detects edges included in the correspondence area AR10 in the line data DA11 for each line data DA11 included in the print data DA10.

For example, the detection processing portion 61B detects, as an edge, a portion of the correspondence area AR10 where a row of the ejection amount data DA12 indicating that the ejection amount of the ink is equal to or larger than the threshold value and a row of the ejection amount data DA12 indicating that the ejection amount of the ink is smaller than the threshold value are adjacent to each other. For example, the detection processing portion 61B detects, as an edge, a portion of the correspondence area AR10 where a row including three or more consecutive pieces of the ejection amount data DA12 indicating that the ejection amount of the ink is equal to or larger than the threshold value and a row including two or more consecutive pieces of the ejection amount data DA12 indicating that the ejection amount of the ink is smaller than the threshold value are adjacent to each other. For example, the threshold value is "1".

When edges are detected by the detection processing portion 61B, the determination processing portion 62B randomly determines the division position in a density area having a relatively high density out of two density areas sectioned by an edge on the upstream side or the downstream side of the second direction D21 out of the edges included in the correspondence area AR10.

For example, the determination processing portion 62B uses the random number table to determine the division position in the density area having a relatively high density out of the two density areas sectioned by the edge that is most upstream or most downstream in the second direction D21 out of the edges included in the correspondence area AR10.

Further, when no edge is detected by the detection processing portion 61B, the determination processing portion 62B randomly determines the division position in the correspondence area AR10.

The change processing portion 63 changes the threshold value according to a predetermined change operation.

For example, the change processing portion 63 causes the operation display portion 5 to display a change operation screen used for accepting the change operation in accordance with a predetermined operation made on the operation display portion 5. Then, when the change operation is accepted in the change operation screen, the change processing portion 63 changes the threshold value according to the accepted change operation.

### Second data division processing

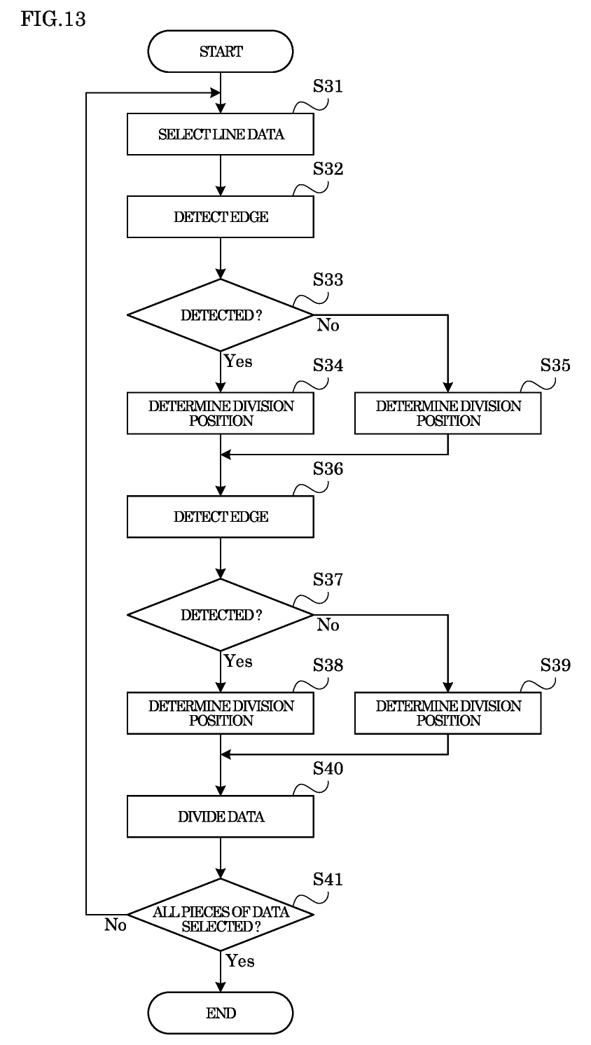

Next, with reference to FIG. 13, the determination method according to the present disclosure will be described along with exemplary procedures of second data division processing executed by the engine control portion 8. It is noted that the engine control portion 8 executes the second data division processing when executing the print processing. In addition, the engine control portion 8 executes the second data division processing for each of the colors of black, cyan, magenta, and yellow.

### Step S31

First, in Step S31, the engine control portion 8 selects one piece of line data DA11 to be divided out of the plurality of pieces of line data DA11 included in the print data DA10 to be printed.

### Step S32

In Step S32, the engine control portion 8 detects edges included in the correspondence area AR10 corresponding to the overlapping area OL10 where the recording head 36A and the recording head 36B overlap in the line data DA11 to be divided. The processing of Step S32 is an example of the detection step according to the present disclosure and is executed by the detection processing portion 61B of the engine control portion 8.

Specifically, the engine control portion 8 detects, as the edge, a portion of the correspondence area AR10 where a row including three or more consecutive pieces of the ejection amount data DA12 indicating that the ejection amount of the ink is equal to or larger than the threshold value and a row including two or more consecutive pieces of the ejection amount data DA12 indicating that the ejection amount of the ink is smaller than the threshold value are adjacent to each other.

### Step S33

In Step S33, the engine control portion 8 determines whether or not an edge has been detected by the processing of Step S32.

Herein, when determining that an edge has been detected (Yes in S33), the engine control portion 8 shifts the processing to Step S34. On the other hand, when determining that an edge has not been detected (No in S33), the engine control portion 8 shifts the processing to Step S35.

### Step S34

In Step S34, the engine control portion 8 determines the division position based on the position of the edge on the upstream side or the downstream side of the second direction D21 out of the edges included in the correspondence area AR10 corresponding to the overlapping area OL10 where the recording head 36A and the recording head 36B overlap. The processing of Step S34 is an example of the determination step according to the present disclosure and is executed by the determination processing portion 62B of the engine control portion 8.

Specifically, the engine control portion 8 randomly determines the division position in the density area having a relatively high density out of the two density areas sectioned by the edge that is most upstream in the second direction D21 out of the edges included in the correspondence area AR10.

### Step S35

In Step S35, the engine control portion 8 randomly determines the division position in the correspondence area AR10 corresponding to the overlapping area OL10 where the recording head 36A and the recording head 36B overlap. The processing of Step S35 is an example of the determination step according to the present disclosure and is executed by the determination processing portion 62B of the engine control portion 8.

### Step S36

In Step S36, the engine control portion 8 detects edges included in the correspondence area AR10 corresponding to the overlapping area OL10 where the recording head 36B and the recording head 36C overlap in the line data DA11 to be divided, by the method similar to that of the processing of Step S32. The processing of Step S36 is an example of the detection step according to the present disclosure and is executed by the detection processing portion 61B of the engine control portion 8.

### Step S37

In Step S37, the engine control portion 8 determines whether or not an edge has been detected by the processing of Step S36.

Herein, when determining that an edge has been detected (Yes in S37), the engine control portion 8 shifts the processing to Step S38. On the other hand, when determining that an edge has not been detected (No in S37), the engine control portion 8 shifts the processing to Step S39.

### Step S38

In Step S38, the engine control portion 8 determines the division position based on the position of the edge on the upstream side or the downstream side of the second direction D21 out of the edges included in the correspondence area AR10 corresponding to the overlapping area OL10 where the recording head 36B and the recording head 36C overlap, by the method similar to that of the processing of Step S34. The processing of Step S38 is an example of the determination step according to the present disclosure and is executed by the determination processing portion 62B of the engine control portion 8.

### Step S39

In Step S39, the engine control portion 8 randomly determines the division position in the correspondence area AR10 corresponding to the overlapping area OL10 where the recording head 36B and the recording head 36C overlap. The processing of Step S39 is an example of the determination step according to the present disclosure and is executed by the determination processing portion 62B of the engine control portion 8.

### Step S40

In Step S40, the engine control portion 8 divides the line data DA11 to be divided into the first line data, the second line data, and the third line data based on the division position determined by the processing of Step S34 or Step S35 and the division position determined by the processing of Step S38 or Step S39.

The first line data, the second line data, and the third line data obtained by the division in the processing of Step S40 are used for driving the three recording heads 36 included in the line head 30. Thus, an image corresponding to the line data DA11 is formed on the sheet.

### Step S41

In Step S41, the engine control portion 8 determines whether or not all pieces of line data DA11 included in the print data DA10 to be printed have been selected by the processing of Step S31.

Herein, when determining that all pieces of line data DA11 have been selected (Yes in S41), the engine control portion 8 ends the second data division processing. On the other hand, when determining that all pieces of line data DA11 have not been selected (No in S41), the engine control portion 8 shifts the processing to Step S31.

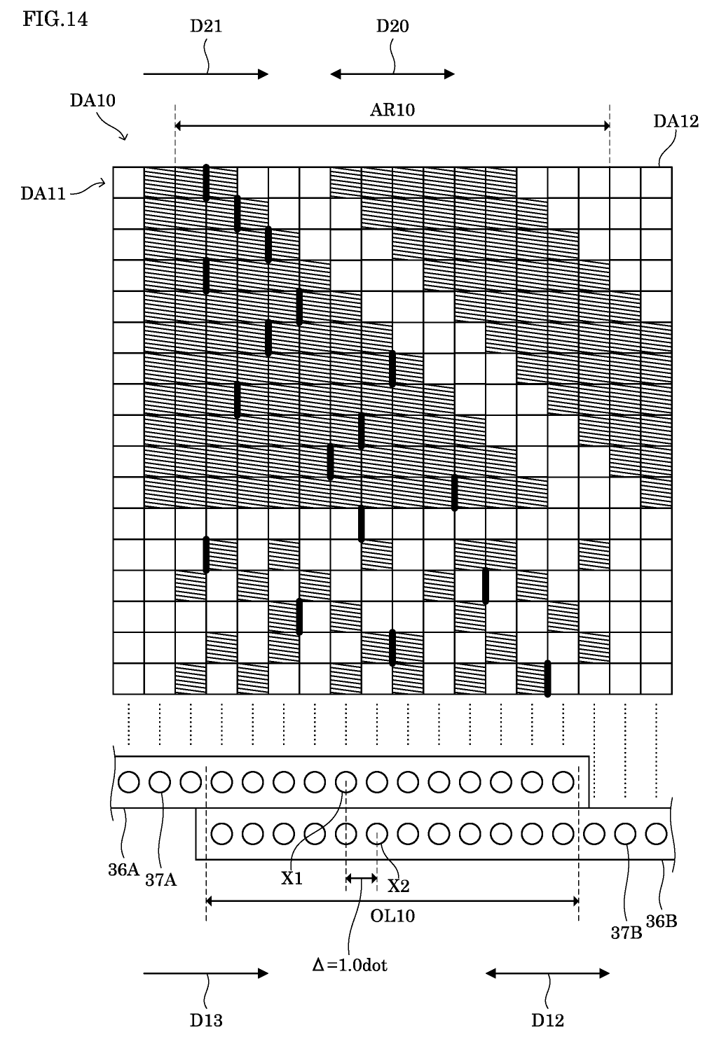

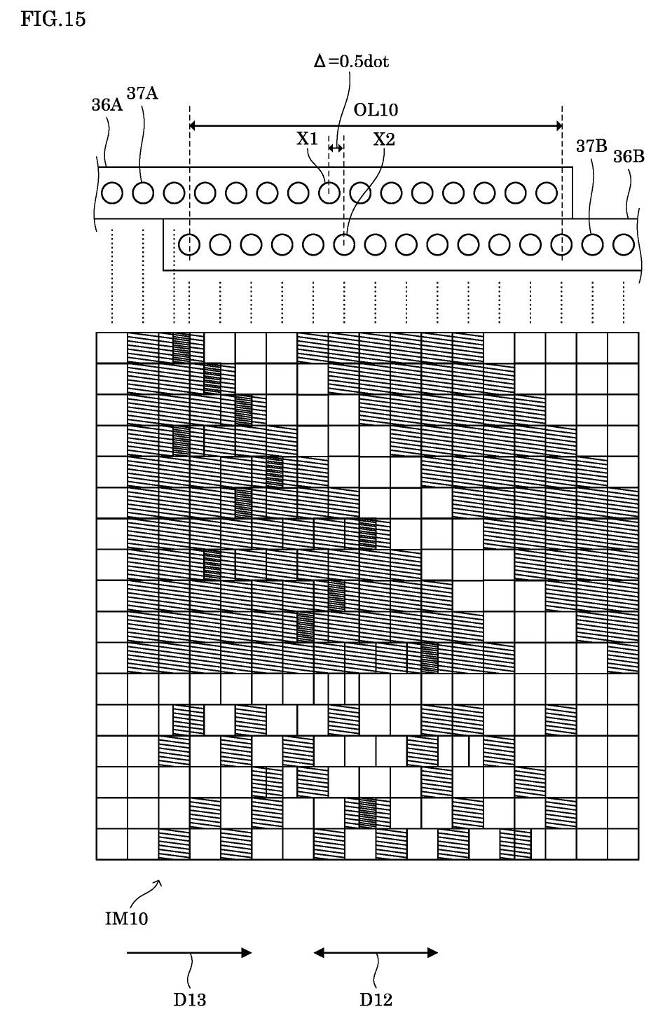

FIG. 14 shows the division positions determined by the second data division processing in the case where the print data DA10 shown in FIG. 10 is printed. Further, FIG. 15 shows the image IM10 formed on the sheet based on the first line data and the second line data obtained by the division in the second data division processing. By randomly determining the division position in a density area having a relatively high density out of the two density areas sectioned by the edge on the upstream side or the downstream side of the second direction D21 out of the edges included in the correspondence area AR10 as shown in FIG. 15, lowering of reproducibility of an open line image that is included in the image IM10 formed on the sheet and extends in the direction intersecting with the width direction D12 is suppressed.

In this manner, in the image forming apparatus 100B, it is possible to suppress the occurrence of jitter at the edges included in the image formed on the sheet, and also suppress lowering of the reproducibility of the open line that is present in the correspondence area AR10 and extends in the direction intersecting with the main scanning direction D20.

### Notes of disclosure

Hereinafter, a general outline of the disclosure extracted from the embodiment described above will be noted. It is noted that the respective configurations and processing functions described in the notes below can be sorted and arbitrarily combined as appropriate.

### Note 1

An image forming apparatus, including: a first ejection portion which includes a plurality of first nozzles arranged along a width direction orthogonal to a conveying direction of a sheet, and causes ink to be ejected from each of the first nozzles; a second ejection portion which includes a plurality of second nozzles arranged along the width direction, some of the plurality of second nozzles being arranged so as to overlap with some of the plurality of first nozzles in the width direction, and causes the ink to be ejected from each of the second nozzles; a detection processing portion which detects, for each line data for one line along a main scanning direction corresponding to the width direction, that is included in image data used for driving the first ejection portion and the second ejection portion, edges included in a correspondence area corresponding to an overlapping portion between the plurality of first nozzles and the plurality of second nozzles in the line data; and a determination processing portion which determines, when the edges are detected by the detection processing portion, a division position for dividing the line data into first line data used for driving the first ejection portion and second line data used for driving the second ejection portion based on a position of the edge on an upstream side or a downstream side of a specific direction along the main scanning direction out of the edges included in the correspondence area, and randomly determines, when the edges are not detected by the detection processing portion, the division position in the correspondence area.

### Note 2

The image forming apparatus according to note 1, in which when the edges are detected by the detection processing portion, the determination processing portion determines the position of the edge on the upstream side or the downstream side of the specific direction out of the edges included in the correspondence area as the division position.

### Note 3

The image forming apparatus according to note 2, in which the line data includes ejection amount data that corresponds to each of the nozzles and indicates an ejection amount of the ink from each of the nozzles, and the detection processing portion detects, as the edge, a portion in the correspondence area where a row of the ejection amount data indicating that the ejection amount of the ink is zero and a row of the ejection amount data indicating that the ejection amount of the ink is not zero are adjacent to each other.

### Note 4

The image forming apparatus according to note 3, in which the detection processing portion executes first detection processing for detecting a first edge where the ejection amount of the ink increases along the specific direction and second detection processing for detecting a second edge where the ejection amount of the ink increases along a direction opposite to the specific direction, in a stated order of the first detection processing and the second detection processing, and the determination processing portion determines, when the first edge is detected by the first detection processing, a position of the first edge that is most upstream in the specific direction as the division position, and determines, when the first edge is not detected by the first detection processing and the second edge is detected by the second detection processing, a position of the second edge that is most downstream in the specific direction as the division position.

### Note 5

The image forming apparatus according to note 1, in which when the edges are detected by the detection processing portion, the determination processing portion randomly determines the division position in, out of two density areas sectioned by the edge on the upstream side or the downstream side of the specific direction out of the edges included in the correspondence area, the density area having a relatively low density.

### Note 6

The image forming apparatus according to note 5, in which the line data includes ejection amount data that corresponds to each of the nozzles and indicates an ejection amount of the ink from each of the nozzles, the detection processing portion executes first detection processing for detecting a first edge where the ejection amount of the ink increases along the specific direction and second detection processing for detecting a second edge where the ejection amount of the ink increases along a direction opposite to the specific direction, in a stated order of the first detection processing and the second detection processing, and the determination processing portion randomly determines, when the first edge is detected by the first detection processing, the division position in, out of the two density areas sectioned by the first edge that is most upstream in the specific direction, the density area having a relatively low density, and randomly determines, when the first edge is not detected by the first detection processing and the second edge is detected by the second detection processing, the division position in, out of the two density areas sectioned by the second edge that is most downstream in the specific direction, the density area having a relatively low density.

### Note 7

The image forming apparatus according to note 1, in which the line data includes ejection amount data that corresponds to each of the nozzles and indicates an ejection amount of the ink from each of the nozzles, the detection processing portion detects, as the edge, a portion in the correspondence area where a row of the ejection amount data indicating that the ejection amount of the ink is zero and a row of the ejection amount data indicating that the ejection amount of the ink is not zero are adjacent to each other, and when the edges are detected by the detection processing portion, the determination processing portion determines the division position in, out of two density areas sectioned by the edge on the upstream side or the downstream side of the specific direction out of the edges included in the correspondence area, the density area having a relatively low density.

### Note 8

The image forming apparatus according to note 7, in which the detection processing portion executes first detection processing for detecting a first edge where the ejection amount of the ink increases along the specific direction and second detection processing for detecting a second edge where the ejection amount of the ink increases along a direction opposite to the specific direction, in a stated order of the first detection processing and the second detection processing, and the determination processing portion determines, when the first edge is detected by the first detection processing, the division position in, out of the two density areas sectioned by the first edge that is most upstream in the specific direction, the density area having a relatively low density, and determines, when the first edge is not detected by the first detection processing and the second edge is detected by the second detection processing, the division position in, out of the two density areas sectioned by the second edge that is most downstream in the specific direction, the density area having a relatively low density.

### Note 9

A determination method executed in an image forming apparatus including a first ejection portion which includes a plurality of first nozzles arranged along a width direction orthogonal to a conveying direction of a sheet, and causes ink to be ejected from each of the first nozzles, and a second ejection portion which includes a plurality of second nozzles arranged along the width direction, some of the plurality of second nozzles being arranged so as to overlap with some of the plurality of first nozzles in the width direction, and causes the ink to be ejected from each of the second nozzles, the determination method including: a detection step of detecting, for each line data for one line along a main scanning direction corresponding to the width direction, that is included in image data used for driving the first ejection portion and the second ejection portion, edges included in a correspondence area corresponding to an overlapping portion between the plurality of first nozzles and the plurality of second nozzles in the line data; and a determination step of determining, when the edges are detected in the detection step, a division position for dividing the line data into first line data used for driving the first ejection portion and second line data used for driving the second ejection portion based on a position of the edge on an upstream side or a downstream side of a specific direction along the main scanning direction out of the edges included in the correspondence area, and randomly determining, when the edges are not detected in the detection step, the division position in the correspondence area.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a first ejection portion which includes a plurality of first nozzles arranged along a width direction orthogonal to a conveying direction of a sheet, and causes ink to be ejected from each of the first nozzles;
a second ejection portion which includes a plurality of second nozzles arranged along the width direction, some of the plurality of second nozzles being arranged so as to overlap with some of the plurality of first nozzles in the width direction, and causes the ink to be ejected from each of the second nozzles;
a detection processing portion which detects, for each line data for one line along a main scanning direction corresponding to the width direction, that is included in image data used for driving the first ejection portion and the second ejection portion, edges included in a correspondence area corresponding to an overlapping portion between the plurality of first nozzles and the plurality of second nozzles in the line data; and
a determination processing portion which determines, when the edges are detected by the detection processing portion, a division position for dividing the line data into first line data used for driving the first ejection portion and second line data used for driving the second ejection portion based on a position of the edge on an upstream side or a downstream side of a specific direction along the main scanning direction out of the edges included in the correspondence area, and randomly determines, when the edges are not detected by the detection processing portion, the division position in the correspondence area.

2. The image forming apparatus according to claim 1, wherein
when the edges are detected by the detection processing portion, the determination processing portion determines the position of the edge on the upstream side or the downstream side of the specific direction out of the edges included in the correspondence area as the division position.

3. The image forming apparatus according to claim 2, wherein
the line data includes ejection amount data that corresponds to each of the nozzles and indicates an ejection amount of the ink from each of the nozzles, and
the detection processing portion detects, as the edge, a portion in the correspondence area where a row of the ejection amount data indicating that the ejection amount of the ink is zero and a row of the ejection amount data indicating that the ejection amount of the ink is not zero are adjacent to each other.

4. The image forming apparatus according to claim 3, wherein
the detection processing portion executes first detection processing for detecting a first edge where the ejection amount of the ink increases along the specific direction and second detection processing for detecting a second edge where the ejection amount of the ink increases along a direction opposite to the specific direction, in a stated order of the first detection processing and the second detection processing, and
the determination processing portion determines, when the first edge is detected by the first detection processing, a position of the first edge that is most upstream in the specific direction as the division position, and determines, when the first edge is not detected by the first detection processing and the second edge is detected by the second detection processing, a position of the second edge that is most downstream in the specific direction as the division position.

5. The image forming apparatus according to claim 1, wherein
when the edges are detected by the detection processing portion, the determination processing portion randomly determines the division position in, out of two density areas sectioned by the edge on the upstream side or the downstream side of the specific direction out of the edges included in the correspondence area, the density area having a relatively low density.

6. The image forming apparatus according to claim 5, wherein
the line data includes ejection amount data that corresponds to each of the nozzles and indicates an ejection amount of the ink from each of the nozzles,
the detection processing portion executes first detection processing for detecting a first edge where the ejection amount of the ink increases along the specific direction and second detection processing for detecting a second edge where the ejection amount of the ink increases along a direction opposite to the specific direction, in a stated order of the first detection processing and the second detection processing, and
the determination processing portion randomly determines, when the first edge is detected by the first detection processing, the division position in, out of the two density areas sectioned by the first edge that is most upstream in the specific direction, the density area having a relatively low density, and randomly determines, when the first edge is not detected by the first detection processing and the second edge is detected by the second detection processing, the division position in, out of the two density areas sectioned by the second edge that is most downstream in the specific direction, the density area having a relatively low density.

7. The image forming apparatus according to claim 1, wherein
the line data includes ejection amount data that corresponds to each of the nozzles and indicates an ejection amount of the ink from each of the nozzles,
the detection processing portion detects, as the edge, a portion in the correspondence area where a row of the ejection amount data indicating that the ejection amount of the ink is zero and a row of the ejection amount data indicating that the ejection amount of the ink is not zero are adjacent to each other, and
when the edges are detected by the detection processing portion, the determination processing portion determines the division position in, out of two density areas sectioned by the edge on the upstream side or the downstream side of the specific direction out of the edges included in the correspondence area, the density area having a relatively low density.

8. The image forming apparatus according to claim 7, wherein
the detection processing portion executes first detection processing for detecting a first edge where the ejection amount of the ink increases along the specific direction and second detection processing for detecting a second edge where the ejection amount of the ink increases along a direction opposite to the specific direction, in a stated order of the first detection processing and the second detection processing, and
the determination processing portion determines, when the first edge is detected by the first detection processing, the division position in, out of the two density areas sectioned by the first edge that is most upstream in the specific direction, the density area having a relatively low density, and determines, when the first edge is not detected by the first detection processing and the second edge is detected by the second detection processing, the division position in, out of the two density areas sectioned by the second edge that is most downstream in the specific direction, the density area having a relatively low density.

9. A determination method executed in an image forming apparatus including a first ejection portion which includes a plurality of first nozzles arranged along a width direction orthogonal to a conveying direction of a sheet, and causes ink to be ejected from each of the first nozzles, and a second ejection portion which includes a plurality of second nozzles arranged along the width direction, some of the plurality of second nozzles being arranged so as to overlap with some of the plurality of first nozzles in the width direction, and causes the ink to be ejected from each of the second nozzles, the determination method comprising:
a detection step of detecting, for each line data for one line along a main scanning direction corresponding to the width direction, that is included in image data used for driving the first ejection portion and the second ejection portion, edges included in a correspondence area corresponding to an overlapping portion between the plurality of first nozzles and the plurality of second nozzles in the line data; and
a determination step of determining, when the edges are detected in the detection step, a division position for dividing the line data into first line data used for driving the first ejection portion and second line data used for driving the second ejection portion based on a position of the edge on an upstream side or a downstream side of a specific direction along the main scanning direction out of the edges included in the correspondence area, and randomly determining, when the edges are not detected in the detection step, the division position in the correspondence area.
